(19) United States
(12) Patent Application Publication
(10) Pub. No.: US 2012/0024606 A1
(43) Pub. Date: Feb. 2, 2012

(54) SYSTEM AND METHOD FOR DIRECTION DRILLING

(76) Inventors: Dimitrios Pirovolou, Rio de Janeiro (BR); Sam Ahmad Zamanian, Sugar Land, TX (US); Hector Arismendi Sanchez, Sugar Land, TX (US)

(21) Appl. No.: 12/845,815

(22) Filed: Jul. 29, 2010

(51) Int. Cl. E21B 7/04; G06G 7/48

(52) U.S. Cl. 175/61; 703/10

(57) ABSTRACT

A system and a method for directional drilling may generate a model of steering behavior which may be used to estimate a position and an orientation of the drill bit during directional drilling. The estimated position and the estimated orientation may be compared to the well plan to determine desired drilling behavior, and the desired drilling behavior may be used to determine a recommended toolface orientation and/or recommended intervals of sliding and rotating to conform the directional drilling to the well plan.

### BACKGROUND

The present disclosure generally relates to a system and a method for directional drilling. More specifically, the present disclosure relates to a system and a method which may estimate a position and an orientation of the drill bit during directional drilling.

To obtain hydrocarbons, a drill bit is driven into the ground surface to create a wellbore through which the hydrocarbons are extracted. Typically, a drill string is suspended within the wellbore, and the drill bit is located at a lower end of sections of drill pipe which form the drill string. The drill string extends from the surface to the drill bit. The drill string has a bottom hole assembly (“BHA”) located proximate to the drill bit.

Directional drilling is the steering of the drill bit so that the drill string travels in a desired direction. Before drilling begins, a well plan is established which indicates a target location and a drilling path to the target location. After drilling commences, the drill string is directed from a vertical drilling path in any number of directions to follow the well plan. Directional drilling may direct the wellbore toward the target location.

Further, directional drilling may form deviated branch wellbores from a primary wellbore. For example, directional drilling is useful in a marine environment where a single offshore production platform may reach several hydrocarbon reservoirs by utilizing deviated wells that may extend in any direction from the drilling platform. In addition, directional drilling may control the direction of the wellbore to avoid obstacles, such as, for example, formations with adverse drilling properties. Directional drilling may also enable horizontal drilling through a reservoir.

Moreover, directional drilling may correct deviation from the drilling path established by the well plan. Typically, the trajectory of the drill bit deviates from the trajectory established by the well plan because of unpredicted characteristics of the formations being penetrated and/or the varying forces that the drill bit and the drill string experience. When such deviation occurs and is detected, directional drilling may move the drill bit back to the drilling path established by the well plan.

Known methods of directional drilling use a mud motor system or a rotary steerable system (“RSS”). For a RSS, the drill string is rotated from the surface, and downhole devices cause the drill bit to drill in the desired direction. A RSS is typically more expensive to operate than a mud motor system. For a mud motor system, the drill pipe is held rotationally stationary during a portion of the drilling operation while the mud motor rotates the drill bit. This operation mode is known as “sliding.” Directional drilling using a mud motor system requires accurate orientation of a bent segment of the mud motor before beginning a “sliding” phase of operation. Rotating the drill string drills the wellbore forward without an angle relative to the previous section of the wellbore, and this operation mode is known as “rotating.” Alternating between sliding and rotating may enable the wellbore to have a desired curvature.

The toolface of the BHA is an angular measurement of the orientation of the BHA relative to the top of the wellbore, known as gravity tool face, or relative to magnetic north, known as magnetic tool face. Rotating the drill string changes the orientation of the toolface of the bent segment in the BHA. To effectively steer the drill bit, the operator or the automated system controlling the directional drilling must determine the current location and position of the drill bit and the toolface orientation. Thereafter, if the drilling direction requires adjustment, the operator or the automated system must rotate the drill string to align the toolface of the bent segment with the desired direction. For example, initiating a sliding phase after a rotating phase requires rotation of the drill string to obtain the proper toolface orientation for the bent segment so that the directional drilling during the subsequent sliding phase provides the intended direction of drilling relative to the previous section of the wellbore.

Data measured at the surface and/or measured downhole is used to determine the current location and position of the drill bit and the toolface orientation. For example, the current location and position of the BHA are determined using measurements of the inclination and the azimuth of the BHA, known as “D&I” measurements. A measurement-while-drilling (MWD) tool located in the upper end of the BHA obtains the D&I measurements. The MWD tool may have an accelerometer and a magnetometer to measure the inclination and azimuth, respectively. The toolface orientation is determined using a toolface sensor which may be connected to the mud motor, and the toolface sensor may use an accelerometer and/or a gyroscope. The toolface sensor is typically closer to the drill bit than the MWD tool.

The D&I measurements are obtained by static surveys made at various time or depth intervals. The operator or the automated system uses the estimated location and the estimated position to control the directional drilling. Accordingly, an accurate estimated location and an accurate estimated position are critical for directional drilling. For example, D&I measurements are typically obtained at a distance from the drill bit, such as, for example, tens of feet. The D&I measurements at this distance from the BHA may not be indicative of the actual D&I at the drill bit, and, accordingly, the estimated location and/or the estimated position of the drill bit may be inaccurate. The directional drilling may be compromised because of the inaccurate estimated location of the drill bit. Accordingly, D&I measurements estimated for locations closer to the drill bit may improve the accuracy of directional drilling.

In addition, moving the drill bit to the drilling path established by the well plan may be difficult after deviation from the drilling path. Accordingly, accurately determining how to direct the drill bit to the course established by the well plan may make directional drilling more consistent and predictable relative to currently known systems.

### BRIEF DESCRIPTION OF THE DRAWINGS

FIG. 1 illustrates a system for directional drilling according to one or more aspects of the present disclosure.

FIG. 2 illustrates a method for directional drilling according to one or more aspects of the present disclosure.

FIG. 3 illustrates a display of directional drilling data determined according to one or more aspects of the present disclosure.

### DETAILED DESCRIPTION OF THE PRESENTLY PREFERRED EMBODIMENTS

The present disclosure generally relates to a system and a method for directional drilling. More specifically, the present disclosure relates to a system and a method which may estimate a position and an orientation of the drill bit during directional drilling and/or may determine intervals of sliding and rotating to conform the directional drilling to a well plan.

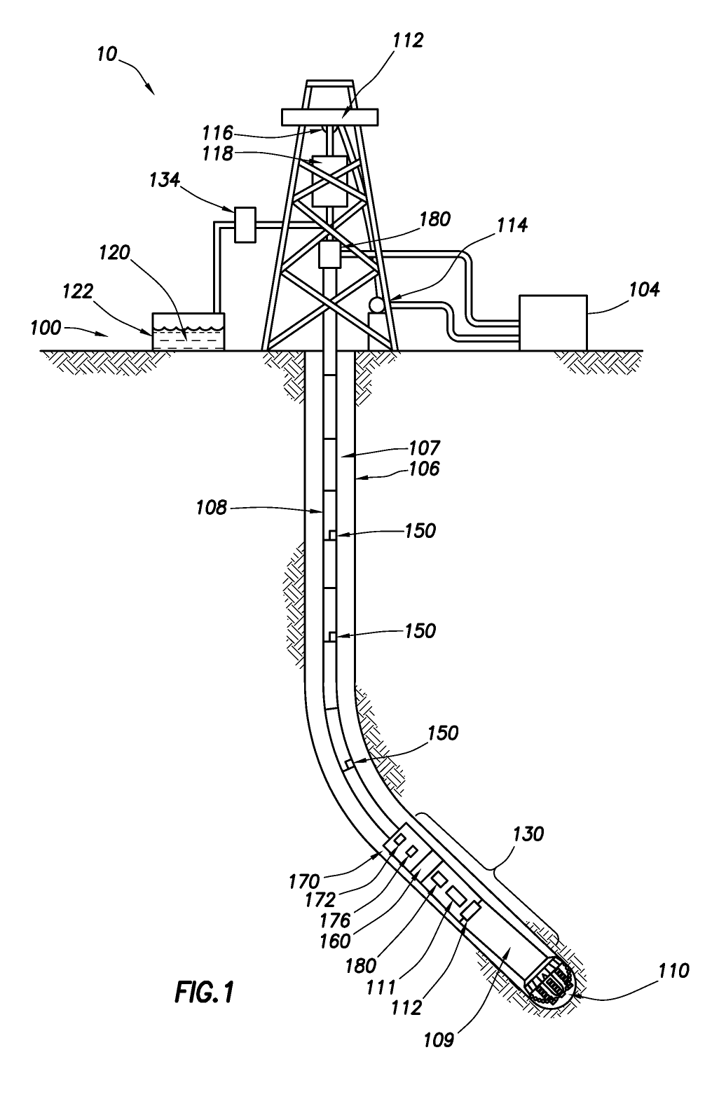

Referring now to the drawings wherein like numerals refer to like parts, FIG. 1 generally illustrates a directional drilling system 10 (hereinafter “the system 10”). A drilling operation may be conducted at a wellsite 100 using the directional drilling system. The wellsite 100 may have a wellbore 106 formed by drilling and/or penetrating one or more subsurface formations.

The system 10 may have a terminal 104. The terminal 104 may be, for example, a desktop computer, a laptop computer, a mobile cellular telephone, a personal digital assistant (“PDA”), a 4G mobile device, a 3G mobile device, a 2.5G mobile device, a satellite radio receiver and/or the like. The terminal 104 preferably has a processor for processing data received by the terminal 104. The terminal 104 may be located at the surface and/or may be remote relative to the wellsite 100. In an embodiment, the terminal 104 may be located in the wellbore 106. The present disclosure is not limited to a specific embodiment or a specific location of the terminal 104, and the terminal 104 may be any device that may be used in the system 10. Any number of terminals may be used to implement the system 10, and the present disclosure is not limited to a specific number of terminals.

The system 10 may have a drill string 108 suspended within the wellbore 106, and a drill bit 110 may be located at the lower end of the drill string 108. The drill string 108 and the walls of the wellbore 106 may form an annulus 107. The system 10 may have a land-based platform and derrick assembly 112 positioned over the wellbore 106. The assembly 112 may have a hook 116, and/or a top drive 118 may be suspended from the hook 116. The top drive 118 may have one or more motors (not shown) and/or may rotate the drill string 108. The assembly 112 may have drawworks 114 to raise, suspend and/or lower the drill string 108. During drilling, the drawworks 114 may be operated to hold the drill string 108 and to control and/or maintain a selected axial force as weight-on-bit (“WOB”) to the drill bit 110. More specifically, a portion of the weight of the drill string 108 is suspended by the drawworks 114, and an unsuspended portion of the weight of drill string 108 is transferred to the drill bit 110 as the WOB. The drawworks 114 may have an encoder (not shown in the drawings) which may be configured to determine the depths of points along the drill string 108. The terminal 104 may be communicatively connected to the encoder to generate a log of depth of the drill bit 110 as a function of time.

Drilling fluid 120 may be stored in a reservoir 122 formed at the wellsite 100. A pump 134 may deliver the drilling fluid 120 to the interior of the drill string 108 to induce the drilling fluid 120 to flow downward through the drill string 108. A mud motor 111 may use the flow of the drilling fluid 120 to generate electrical power. The drilling fluid 120 may exit the drill string 108 through ports or nozzles (not shown) in the drill bit 110 and then may circulate upward through the annulus 107. Thus, the drilling fluid 120 may lubricate the drill bit 110 and may carry formation cuttings up to the surface as the drilling fluid 120 returns to the reservoir 122 for recirculation.

Sensors 150 at various locations at the wellsite 100 may collect data, preferably in real-time, concerning the operation and the conditions of the wellsite 100. The sensors 150 may have image generation capabilities. For example, one or more of the sensors 150 may be sensors which may provide information about surface conditions, such as, for example, standpipe pressure, hookload, depth, surface torque, rotary rpm and/or the like. One or more of the sensors 150 may be downhole sensors and/or may be disposed within the wellbore 106 to provide information about downhole conditions, such as, for example, wellbore pressure, weight-on-bit, torque-on-bit, direction, inclination, collar rpm, tool temperature, annular temperature, toolface, along-string measurements and/or the like. The information obtained by the sensors 150 may be transmitted to various components of the system 10, such as, for example, the terminal 104.

The drill string 108 may have a BHA 130 proximate to the drill bit 110. The drill bit 110 may be connected to a bent sub 109 which may be angled relative to the BHA 130. In an embodiment, the bent sub 109 may be angled approximately two degrees or less relative to the BHA 130. In an embodiment, the mud motor 111 may be connected to the bent sub 109 and/or may rotate the bent sub 109 and/or the drill bit 110 without rotation of the drill string 108. The mud motor 111 and/or the bent sub 109 may be connected to a mechanical transmission 112. The mechanical transmission 112 may prevent rotation of the bent sub 109 relative to the remainder of the drill string 108 if the drill string 108 is rotating. The mechanical transmission 112 may enable the mud motor 111 to rotate the bent sub 109 if the drill string 108 is sliding. Within the bent sub, may be a drive shaft attached to the mud motor 111 and the drill bit 110.

The BHA 130 may have one or more tools for measuring, processing and/or storing information and/or communicating with the terminal 104. Additionally, the BHA 130 may have mud motors, rotary steerable assemblies and/or reamers which may divert a portion of the drilling fluid 120 to the annulus.

For example, the BHA 130 may have a logging-while-drilling (LWD) module 160. The LWD module 160 may be housed in a drill collar of the BHA 130 and may have one or more known types of logging tools. The LWD module 160 may have capabilities for measuring and processing data acquired from and/or through the wellbore 106. In addition, the LWD module 160 may measure properties of the one or more subsurface formations adjacent to the wellbore 106.

The BHA 130 may have a measuring-while-drilling (MWD) module 170. The MWD module 170 may be housed in a drill collar located at the upper end of the BHA 130 and may have one or more devices for measuring characteristics of the drill string 108 and the drill bit 110. For example, the MWD module 170 may measure physical properties, such as, for example, pressure, temperature and/or wellbore trajectory. The MWD module 170 may have a D&I sensor 172 which may determine the inclination and the azimuth of the BHA 130. For example, the D&I sensor 172 may use an accelerometer and/or a magnetometer to determine the inclination and the azimuth of the BHA 130. The D&I sensor 172 may use any means for determining the inclination and the azimuth of the BHA 130 known to one having ordinary skill in the art.

The BHA 130 may have a toolface sensor 180 which determines the toolface orientation of the BHA 130. The toolface sensor 180 may use one or more magnetometers and/or one or more accelerometers to determine the azimuthal orientation of the BHA 130 relative to the earth's magnetic north and/or may use one or more gravitation sensors to determine the azimuthal orientation of the BHA 130 relative to the earth's gravity vector. The toolface sensor 180 may use any means for determining the toolface orientation of the BHA 130 known to one having ordinary skill in the art.

The MWD module 170 may have a mud flow telemetry device 176 which may selectively block passage of the drilling fluid 20 through the drill string 108. The mud flow telemetry device 176 may transmit data from the BHA 130 to the surface by modulation of the pressure in the drilling fluid 20. Modulated changes in pressure may be detected by a pressure sensor 180 communicatively connected to the terminal 104. The terminal 104 may interpret the modulated changes in pressure to reconstruct the data sent from the BHA 130. For example, the mud flow telemetry device 176 may transmit the inclination, the azimuth and the toolface orientation to the surface by modulation of the pressure in the drilling fluid 20, and the terminal 104 may interpret the modulated changes in pressure to obtain the inclination, the azimuth and the toolface orientation of the BHA 130. The mud pulse telemetry may be implemented using a system such as that described in U.S. Pat. No. 5,517,464 assigned to the assignee of the present disclosure and incorporated by reference in its entirety. Alternatively, wired drill pipe, electromagnetic telemetry and/or acoustic telemetry may be used instead of or in addition to mud pulse telemetry. For example, mud pulse telemetry may be used in conjunction with or as backup for wired drill pipe as described hereafter.

Wired drill pipe may communicate signals along electrical conductors in the wired drill pipe. Wired drill pipe joints may be interconnected to form the drill string 108. The wired drill pipe may provide a signal communication conduit communicatively coupled at each end of each of the wired drill pipe joints. For example, the wired drill pipe preferably has an electrical and/or optical conductor extending at least partially within the drill pipe with inductive couplers positioned at the ends of each of the wired drill pipe joints. The wired drill pipe may enable communication of the data from the BHA 130 to the terminal 104. Examples of wired drill pipe that may be used in the present disclosure are described in detail in U.S. Pat. Nos. 6,641,434 and 6,866,306 to Boyle et al. and U.S. Pat. No. 7,413,021 to Madhavan et al. and U.S. Patent App. Pub. No. 2009/0166087 to Braden et al., assigned to the assignee of the present application and incorporated by reference in their entireties. The present disclosure is not limited to a specific embodiment of the telemetry system. The telemetry system may be any system capable of transmitting the data from the BHA 130 to the terminal 104 as known to one having ordinary skill in the art.

The wellbore 106 may be drilled according to a well plan established prior to drilling. The well plan typically sets forth equipment, pressures, trajectories and/or other parameters that define the drilling process for the wellsite 100. The well plan may establish a target location, such as, for example, a location within or adjacent to a reservoir of hydrocarbons, and/or may establish a drilling path by which the drill bit 110 may travel to the target location. The drilling operation may be performed according to the well plan. However, as the information is obtained, the drilling operation may need to deviate from the well plan. For example, as drilling or other operations are performed, the subsurface conditions may change, and the drilling operation may require adjustment.

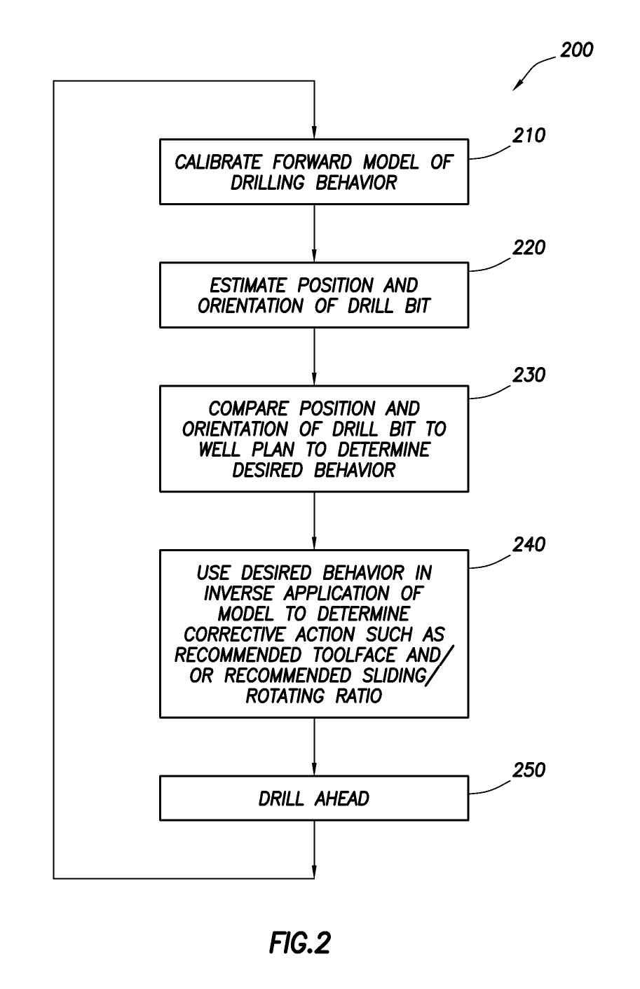

FIG. 2 generally illustrates a method 200 for directional drilling. Computer readable medium, such as, for example, a compact disc, a DVD, a computer memory, a hard drive and/or the like, may enable the terminal 104 to perform the method 300 and/or be used in the system 10. In step 210, the terminal 104 may use measurements of the inclination, the azimuth and/or the toolface orientation of the BHA 130 to calibrate a forward model of drilling behavior of the BHA 130. The toolface sensor 180 may measure the toolface orientation of the BHA 130 at a plurality of times, and/or the D&I sensor 172 may measure the inclination and the azimuth of the BHA 130 at a plurality of times. Moreover, the sensors 150 may provide additional measurements obtained at a plurality of times, such as, for example, a depth, a rate of penetration, a pressure differential across the mud motor 111, and/or the like.

The D&I sensor 172, the toolface sensor 180 and/or the sensors 150 may transmit the measurements of the inclination and the azimuth, the measurements of the toolface orientation and/or the additional measurements (collectively hereinafter “the measurements”), respectively, to the terminal 104. For example, the D&I sensor 172, the toolface sensor 180 and/or the sensors 150 may transmit the measurements using the mud flow telemetry device 176. The measurements may be transmitted to the terminal 104 using any means known to one having ordinary skill in the art.

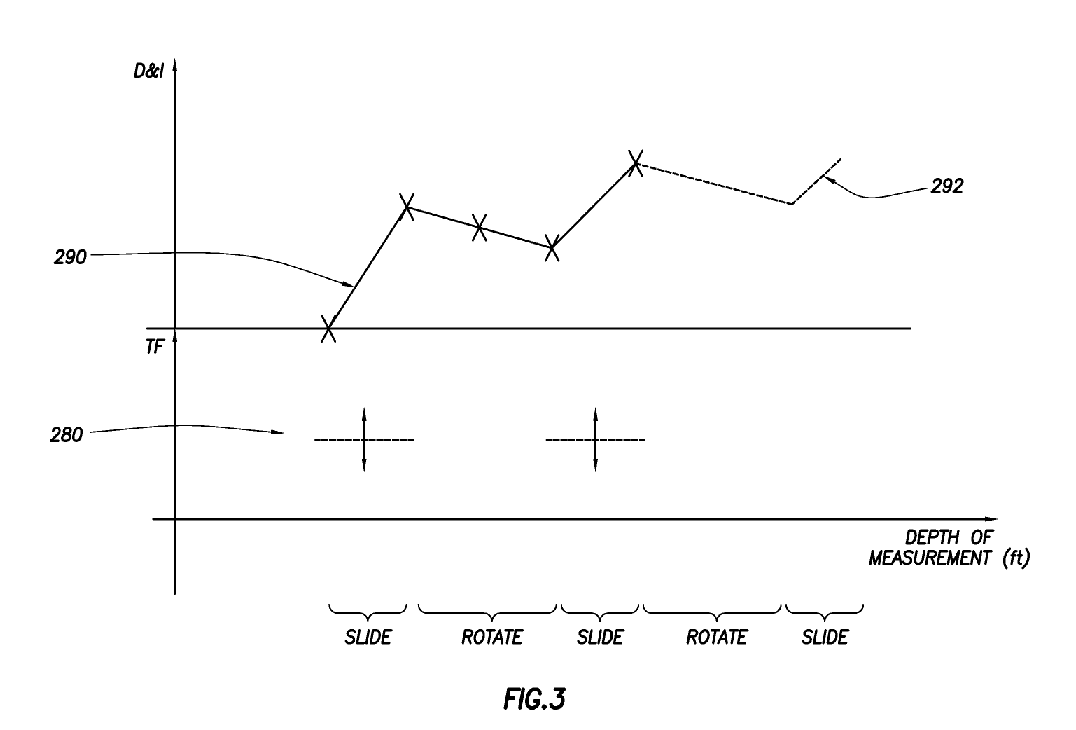

As generally shown in FIG. 3, the terminal 104 may use the measurements of the toolface orientation obtained at a plurality of times to generate a plot 280 of the toolface orientation as a function of depth. The terminal 104 may use the measurements of the inclination and the azimuth obtained at a plurality of times to generate a plot 290 of D&I measurements as a function of depth. The terminal 104 may have a log of depth as a function of time and may use the measurements with the log to generate the plot 280 and/or the plot 290. For example, the log of depth as a function of time may be based on the additional measurements and/or data obtained at the surface, such as, for example, data obtained by the encoder of the drawworks 114. Moreover, in an embodiment, the terminal 104 may use the additional measurements to generate a plot of rate of penetration as a function of depth (not shown) and/or a plot of pressure differential across the mud motor 111 as a function of depth (not shown).

The terminal 104 may use the plot 290 of the D&I measurements to interpolate a curve connecting the D&I data points using any interpolation method known to one having ordinary skill in the art. For example, an algorithm, such as a linear regression algorithm, may be used to interpolate the curve connecting the D&I data points. In an embodiment, the curve may be a polynomial curve. The system 10 and the method 200 are not limited to a specific embodiment of the curve or a specific method of interpolating the curve, and the system 10 and the method 200 may use any mathematical function suitable for modeling the drilling behavior of the BHA 130.

The input for calibrating the model may be data regarding the wellbore 106 and/or other wellbores which have previously been drilled. For example, the model may be based on data regarding other wellbores which were drilled with a similar BHA 130 and/or a similar drill bit 110. In an embodiment, drilling of the wellbore 106 may be initiated using a model of the drilling behavior of the BHA 130 generated from data from other wellbores.

Further, the input for the model may be drilling parameters associated with the measurements. For example, one or more of the parameters may be the measurements of the inclination, the azimuth and/or the toolface orientation. As a further example, one of the parameters may be the WOB because the toolface orientation may variate more at a higher WOB relative to a lower WOB. As a further example, one or more of the parameters may be properties of the subsurface formation through which the BHA 130 is drilling, the geometry of the BHA 130, the flow rate of the drilling fluid 20, the rotation speed of the drill string 108, operation mode of the drill string 108 as sliding or rotating, the rotation speed of the drill bit 110, and/or the like. Accordingly, the terminal 104 may use the additional measurements to calibrate the forward model of drilling behavior of the BHA 130.

As the wellbore 106 is drilled to greater depths, more data is acquired. The measurements may be periodically obtained, and the increase in the amount of data may improve the accuracy of the forward model of the drilling behavior of the BHA 130. For example, the inclination, the azimuth, the toolface orientation, the rate of penetration and/or the pressure differential across the mud motor 111 may be periodically determined, and the forward model of the drilling behavior of the BHA 130 may be adjusted to account for the newly obtained measurements. Accordingly, the model may be periodically calibrated using data acquired downhole.

During periodic calibration of the forward model of the drilling behavior of the BHA 130, the terminal 104 may compare measurements of the inclination and/or the azimuth to values previously estimated from the model. Then, the terminal 104 may adjust the model to minimize any difference between the measurements and the estimated values. Calibration may use a least squares method, a least mean squares method, curve fitting and/or the like; however, any mathematical optimization technique for fitting a mathematical function to a data set may be used.

For example, the terminal 104 may estimate values for the inclination, the azimuth and/or the toolface orientation for one or more selected depths before the D&I sensor 172 and/or the toolface sensor 180, respectively, reach the one or more selected depths. Then, after the D&I sensor 172 and/or the toolface sensor 180 reach the one or more selected depths, the terminal 104 may compare the measurements obtained at the selected depth to the value estimated for the selected depth. Then, the terminal 104 may adjust the forward model of the drilling behavior of the BHA 130 to minimize any difference between the measurements and the estimated values. For example, the terminal 104 may compare the measurements obtained at a plurality of selected depths to the values estimated for the plurality of selected depths to produce a best fit model. Accordingly, the terminal 104 may re-calibrate the forward model of the drilling behavior of the BHA 130 by comparing the measurements to the estimated values.

In an embodiment, in step 210, the terminal 104 may determine how curvature of the drilling is affected by variance in the toolface orientation. The terminal 104 may use the measurements of the toolface orientation obtained by the toolface sensor 180 to determine variation of the toolface orientation from expected values. Then, the terminal 104 may use the measurements of the inclination and/or the azimuth obtained by the D&I sensor 172 to determine a correlation between the variance of the toolface orientation from the expected values and any variation of the measurements of the inclination and/or the azimuth from the expected values. The correlation between the variance of the toolface orientation from the expected values and any variation of the measurements of the inclination and/or the azimuth from the expected values may be used to calibrate the forward model of the drilling behavior of the BHA 130.

In an embodiment, the terminal 104 may use a variance threshold to determine the accuracy of the model. If the difference between the measurements and the estimated values is equal to or less than the variance threshold, the terminal 104 may determine that the model has sufficient accuracy. If the difference between the measurements and the estimated values is more than the variance threshold, the terminal 104 may adjust the model to reduce the difference to below the variance threshold and/or may continue to calibrate the model using data obtained subsequent to the comparison.

Referring again to FIG. 2, in step 220, the terminal 104 may estimate a position of the drill bit 110 at one or more depths using the forward model of the drilling behavior of the BHA 130 calibrated in step 210. For example, the terminal 104 may estimate the azimuth, the inclination and/or the toolface orientation for the drill bit 110 at one or more depths. In an embodiment which determines the accuracy of the model, the terminal 104 may use the model to estimate the azimuth and/or the inclination of the drill bit 110 if the terminal 104 determines that the model has sufficient accuracy. As generally shown in FIG. 3, the terminal 104 may generate an extrapolated curve 292 to indicate estimated values for the azimuth and/or the inclination of the drill bit 110.

For a selected depth, the terminal 104 may use the model and/or the drilling parameters set forth by the well plan for the selected depth to determine the estimated values for the azimuth and/or the inclination of the drill bit 110 at the selected depth. For example, the terminal 104 may determine the estimated values using the model, the WOB at the selected depth, properties of the formation through which the BHA 130 drills at the selected depth, the geometry of the BHA 130, the flow rate of the drilling fluid 20 at the selected depth, the rotation speed of the drill string 108 at the selected depth, operation mode of the drill string 108 as sliding or rotating at the selected depth, the rotation speed of the drill bit 110 at the selected depth, and/or the like.

In an embodiment, the terminal 104 may estimate a position of the drill bit 110 at one or more depths by estimating a direction rate of change and/or an inclination rate of change at the drill bit 110. The terminal 104 may use the model, the measurements and/or the drilling parameters established by the well plan to estimate the direction rate of change and/or the inclination rate of change. The terminal 104 may use the direction rate of change and/or the inclination rate of change with the D&I measurements to estimate the position of the drill bit 110 at one or more depths.

As generally shown in step 230, the terminal 104 may compare the estimated position of the drill bit 110 to the well plan. For example, the terminal 104 may compare the estimated values for the azimuth and/or the inclination of the drill bit 110 to the well plan. The terminal 104 may compare the estimated values for the azimuth and/or the inclination to the closest point on the drilling path established by the well plan. Alternatively, the terminal 104 may compare the estimated values for the azimuth and/or the inclination to the target location established by the well plan. Based on comparison of the well plan to the estimated values for the azimuth and/or the inclination, the terminal 104 may determine desired drilling behavior, such as, for example, well curvature and/or toolface orientation. The well curvature determined by the terminal 104 may be build curvature and/or turn curvature. For example, the terminal 104 may determine the drilling behavior which will direct the drill bit 110 to the target location established by the well plan or to the closest point on the drilling path established by the well plan.

As generally shown in step 240, the terminal 104 may determine a recommended toolface orientation for sliding and/or may determine a recommended rotating/sliding ratio. For example, the terminal 104 may use the desired drilling behavior determined in step 230 in an inverse application of the forward model of the drilling behavior of the BHA 130 determined in step 210 to determine the recommended toolface orientation for sliding and/or the recommended rotating/sliding ratio. The terminal 104 may determine a recommended number of intervals of sliding and/or a recommended number of intervals of rotating over a specified time period to conform the directional drilling to the well plan. In addition, the terminal 104 may determine an amount of time for each of the intervals and/or a total amount of time in which to use the recommended rotating/sliding ratio. In an embodiment, the terminal 104 may determine a recommended WOB and/or a recommended flow rate of the drilling fluid 20 to prevent motor stalling and/or to conform the directional drilling to the well plan.

As generally shown in step 250, the drill bit 110 may drill ahead using the recommended toolface orientation for sliding and/or the recommended rotating/sliding ratio determined in step 240. In an embodiment, the terminal 104 may automatically implement the recommended toolface orientation for sliding and/or the recommended rotating/sliding ratio without the need for user input. The terminal 104 may automatically implement the recommended toolface orientation for sliding and/or the recommended rotating/sliding ratio by automatically transmitting one or more control signals. Moreover, the terminal 104 may automatically implement the recommended WOB and/or the recommended flow rate of the drilling fluid 20.

For example, the terminal 104 may implement the recommended toolface orientation for sliding and/or the recommended rotating/sliding ratio by automatically transmitting controls signals which direct the drill bit 110 to the target location established by the well plan or to the closest point on the drilling path established by the well plan. The terminal 104 may implement the recommended toolface orientation for sliding and/or the recommended rotating/sliding ratio by transmitting control signals which control rotation of the drill string 108 and/or the bent sub 109. For example, the control signals may control operation of the top drive 118, the mud motor 111 and/or the mechanical transmission 112. If the terminal 104 determines a recommended WOB, the terminal 104 may transmit control signals which cause the drill string 108 to have the recommended WOB, such as, for example, by controlling the drawworks 114. If the terminal 104 determines a recommended flow rate of the drilling fluid 20, the terminal 104 may transmit control signals which cause the drill string 108 to have the recommended flow rate of the drilling fluid 20, such as, for example, by controlling the pump 134. Thus, the terminal 104 may automatically correct for deviation to conform the directional drilling to the well plan.

In another embodiment, an operator may use the recommended toolface orientation for sliding, the recommended rotating/sliding ratio, the recommended WOB and/or the recommended flow rate of the drilling fluid 20 to guide the drill bit 110 in step 250. For example, the terminal 104 may display the recommended toolface orientation for sliding, the recommended rotating/sliding ratio, the recommended WOB and/or the recommended flow rate of the drilling fluid 20 to the operator. Then, the terminal 104 may accept user input from the operator to control the drilling operation. For example, the operator may control the top drive 118, the mud motor 111 and/or the mechanical transmission 112 to achieve the recommended rotating/sliding ratio and/or the recommended toolface orientation. As another example, the operator may control the drawworks 114 to achieve the recommended WOB. As yet another example, the operator may control the pump 134 to achieve the recommended flow rate of the drilling fluid 20. The terminal 104 may transmit control signals in response to the user input from the operator to effectuate commands of the operator.

Therefore, the system 10 and the method 200 may generate a forward model of directional drilling behavior of the BHA 130. Further, the system 10 and the method 200 may use the model and drilling parameters to estimate a position and an orientation of the drill bit 110. The estimated position and the estimated orientation may be compared to the well plan to determine desired drilling behavior, and the desired drilling behavior may be used to determine a recommended toolface orientation for sliding and/or recommended intervals of sliding and rotating to conform the directional drilling to the well plan.

It should be understood that various changes and modifications to the presently preferred embodiments described herein will be apparent to those having ordinary skill in the art. Such changes and modifications may be made without departing from the spirit and scope of the present disclosure and without diminishing its attendant advantages. It is, therefore, intended that such changes and modifications be covered by the claims.

We claim:

1. A method for directional drilling of a drill string suspended in a wellbore and having a drill bit connected thereto, the method comprising:
obtaining first downhole measurements regarding a position of the drill string at a plurality of times at a distance from the drill bit;
generating a model of directional drilling behavior based on the first downhole measurements; and
determining an estimated position of the drill bit using the model and the first downhole measurements.

2. The method of claim 1 further comprising:
periodically calibrating the model by minimizing variance between the model and second downhole measurements obtained at intervals subsequent to the first downhole measurements.

3. The method of claim 1 further comprising:
determining variation between the estimated position of the drill bit and a target location established by the well plan.

4. The method of claim 1 further comprising:
using a linear regression algorithm to generate the model wherein a terminal communicatively connected to the sensors generates the model and determines the estimated position of the drill bit.

5. The method of claim 1 further comprising:
measuring an inclination, an azimuth and a toolface orientation of the bottom-hole assembly wherein the downhole measurements include the inclination, the azimuth and the toolface orientation of the bottom-hole assembly.

6. The method of claim 1 further comprising:
determining a curvature of the wellbore for subsequent drilling wherein the curvature directs the drill bit from the estimated position to a location established by a well plan.

7. The method of claim 1 further comprising:
using the first downhole measurements to determine a correlation between variation in the toolface orientation and variation in curvature of the wellbore during sliding wherein the correlation is used to generate the model of directional drilling behavior.

8. A system for directional drilling of a drill string suspended in a wellbore wherein the drill string has a drill bit, the system comprising:
a first sensor obtaining measurements of inclination and azimuth of the drill string at a distance from the drill bit;
a second sensor connected to the drill string, wherein the second sensor obtains measurements of toolface orientation of the drill bit relative to the drill string; and
a terminal communicatively connected to the first sensor and the second sensor wherein the terminal uses the measurements of the inclination and the azimuth of the first sensor and the measurements of the toolface orientation of the second sensor to generate a model of drilling behavior and further wherein the terminal uses the model to determine an estimated position of the drill bit and further wherein the terminal compares the estimated position to a well plan to determine corrective action for subsequent drilling.

9. The system of claim 8 further comprising:
a mud motor mechanically coupled to a bent sub to rotate the drill bit wherein the bent sub is angled relative to the drill string and further wherein the terminal controls the mud motor during the subsequent drilling to perform the corrective action.

10. The system of claim 8 wherein the terminal determines a recommended toolface orientation and a recommended rotate/slide ratio.

11. The system of claim 10 further wherein the terminal performs the corrective action by automatically transmitting one or more signals which implement the recommended toolface orientation and the recommended rotate/slide ratio for the drill string.

12. The system of claim 8 further comprising:
a third sensor located adjacent to a mud motor of the bottom-hole assembly wherein the third sensor obtains measurements of a pressure differential across the mud motor and further wherein the terminal uses the measurements of the pressure differential to generate the model of drilling behavior.

13. A method for directional drilling of a drill string suspended in a wellbore wherein the drill string has a drill bit, the method comprising:
generating a model of directional drilling behavior of the drill string having the drill bit; and
determining an estimated inclination and an estimated azimuth of the drill bit using the model, measurements obtained in the wellbore and parameters established by a well plan for the wellbore;
comparing the estimated inclination and the estimated azimuth of the drill bit to the well plan to determine a deviation of the drill bit from the well plan; and
determining a corrective action to correct the deviation.

14. The method of claim 13 wherein the model is generated using data acquired during drilling of a different wellbore.

15. The method of claim 13 further comprising:
determining a recommended sliding/rotating ratio for the drill string wherein the corrective action includes implementing the recommended sliding/rotating ratio for the drill string.

16. The method of claim 13 further comprising:
determining a recommended toolface orientation of the drill bit wherein the corrective action includes implementing the recommended toolface orientation.

17. The method of claim 13 further comprising:
obtaining measurements of a position of the drill string at a distance from the drill bit at a plurality of times wherein the model is based on the measurements.

18. The method of claim 13 further comprising:
determining a direction rate of change and an inclination rate of change for the drill bit using the model, the measurements obtained in the wellbore and the parameters established by a well plan for the wellbore wherein the estimated inclination and the estimated azimuth of the drill bit is based on the direction rate of change and the inclination rate of change for the drill bit.

19. The method of claim 13 further comprising:
calibrating the model by minimizing variance between the model and data obtained after generating the model.

20. The method of claim 13 further comprising:
determining at least one of a recommended weight-on-bit and a recommended drilling fluid flow rate wherein the corrective action includes using the at least one of the recommended weight-on-bit and the recommended drilling fluid flow rate.
